(19) United States
(12) Patent Application Publication
(10) Pub. No.: US 2006/0245548 A1
(43) Pub. Date: Nov. 2, 2006

(54) X-ray backscatter inspection with coincident optical beam

(76) Inventors: Joseph Callerame, Waltham, MA (US); William Wade Sapp JR., Melrose, MA (US); Jeffrey Schubert, Somerville, MA (US); Richard Schueller, Chelmsford, MA (US)

Correspondence Address: BROMBERG & SUNSTEIN LLP, 125 SUMMER STREET, BOSTON, MA, 02110-1618, US

(21) Appl. No.: 11/409,513

(22) Filed: Apr. 21, 2006

Related U.S. Application Data
(60) Provisional application No. 60/673,887, filed on Apr. 22, 2005.

(51) Int. Cl. G01N 23/04; G01N 23/201; G21K 1/04

(52) U.S. Cl. 378/160; 378/87; 378/57

(57) ABSTRACT

Apparatus and methods that permit an operator of a backscatter x-ray system to shine a search light on a closed container or vehicle, and then image the contents of that container in a region roughly corresponding to the area of the container covered by the search light. A display near the operator presents the backscatter image of the container contents.

The present application claims priority from U.S. Provisional Application Ser. No. 60/673,887, filed Apr. 22, 2005, which application is incorporated herein by reference.

### FIELD OF THE INVENTION

The present invention generally relates to backscatter imaging systems, and specifically to techniques for designating and controlling the area to be inspected at significant distances from the inspected object.

### BACKGROUND ART

Current x-ray imaging systems typically make use of a relatively wide angle fan beam exiting an X-ray tube. From this radiation source, a moving collimator, usually (but not always) in the form of a rotating wheel with one or more appropriately placed apertures, sequentially selects a small portion of this fan beam at each instant of time, scanning the object under inspection with a collimated beam whose position as a function of time is accurately known. Thus, point by point, a one-dimensional Backscatter image is created by collecting backscattered radiation from each irradiated pixel for each collimator scan cycle. During this scan cycle, either the object under inspection or the X-ray source and collimator are moving in a direction orthogonal to the beam scan direction, this creating a two dimensional image of the object. X-ray backscatter systems of this sort are described in U.S. Pat. No. 5,764,683 (Swift et al., issued Jun. 5, 1998), for example, which is herein incorporated by reference.

In current systems, as described with reference to FIG. 2, the angular coverage of the X-ray beam is determined by the angular extent of the x-ray beam as it exits an x-ray tube 1, combined with the collimation technique of the subsystem 4 that picks off a pencil-shaped portion of the fan beam that is produced and directs this pencil beam toward the object under inspection, scanning it, point by point, typically in a vertical direction. This collimation subsystem is typically in the form of a set of rotating collimators 50 mounted on a wheel 4 (generally referred to as a chopper wheel). As an example, a tube with a 60 degree wide x-ray beam is able to subtend a maximum angle of 60 degrees. As a consequence, at a distance of 4 feet away from the tube focal spot, the beam is able to scan an object that is approximately 7 feet high. Moving the object farther away enables taller objects to be completely covered, although the increased distance leads to lower x-ray flux.

### SUMMARY OF THE INVENTION

Embodiments of the present invention are directed to inspection systems designed for inspecting an object. An inspection system, in accordance with preferred embodiments of the invention, has a source of penetrating radiation characterized by a range of wavelengths, where the source may be an x-ray tube, or a gamma ray source, etc. Within the scope of the invention, the spectral range of the source may be substantially monochromatic or broad. Additionally, the inspection system has a spatial modulator for forming the penetrating radiation into a beam of penetrating radiation for irradiating the object with a profile scanned in two dimensions. A remote spatial registration mechanism defines an area at the object substantially contiguous with the profile scanned by the penetrating radiation, while a detector module detects a scatter signal of penetrating radiation from contents of the object.

In accordance with other embodiments of the present invention, the spatial modulator may include some or all of a chopper wheel, a rotating stage, and a translating stage. The remote spatial registration mechanism may include a source of electromagnetic radiation at a wavelength distinct from that of the range of wavelengths of the penetrating radiation, for subtending an area at the object substantially contiguous with the profile scanned by the penetrating radiation. In particular, the electromagnetic radiation at a wavelength distinct from that of the range of wavelengths of the penetrating radiation may be a visible searchlight beam.

In accordance with still other embodiments of the present invention, the remote spatial registration mechanism may include a camera used to define the target area. The source of penetrating radiation and the detector module may be coupled to the same or different conveyances, either or both of which may be a vehicle capable of road travel, whether autonomously or as a conveyance towed by another vehicle. The source of penetrating radiation may be chosen from a group including an x-ray tube and a source of gamma rays, and may include one or more rotating chopper wheels with apertures scanning past an x-ray or gamma ray source for the purpose of generating a scanning pencil beam.

In yet other embodiments of the invention, the source of penetrating radiation may include an aperture that is mechanically moved in a rectilinear fashion along with the x-ray source or that is mechanically moved in a rotational fashion along with the x-ray source. Multiple rotating chopper wheels may be interchangeable by automated or other means, in order to permit the field of view to be narrowed or widened, using different aperture sizes.

The distance to the object under inspection may be determined by one or more sensors, including radar, ultrasound, optical, and/or laser sensors, and may be noted on the image screen to help the viewer assess the actual size of a perceived threat. Additionally, moveable vanes may be positioned in front of the detector module to limit radiation received to that scattered from the targeted region.

### BRIEF DESCRIPTION OF THE DRAWINGS

FIG. 1 illustrates the basic principles of a backscatter beam forming and imaging system.

FIG. 2 shows the principle of a change in the field of view as a function of distance from an x-ray source, in the prior art.

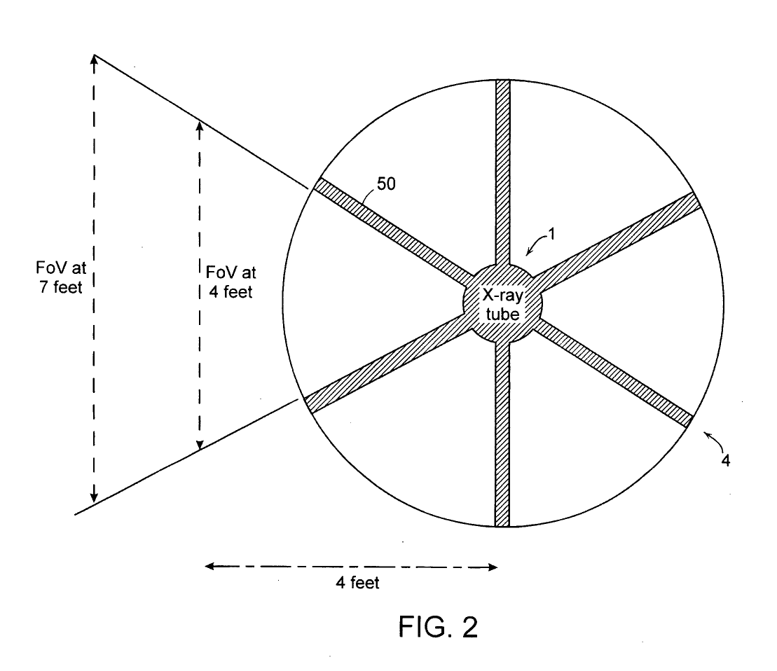

FIG. 3 shows a backscatter scanning technique used to create a long range backscatter image in accordance with an embodiment of the present invention.

FIG. 4 shows a backscatter scanning technique employing a coincident optical beam for long-range backscatter imaging in accordance with an embodiment of the present invention.

### DETAILED DESCRIPTION OF SPECIFIC EMBODIMENTS

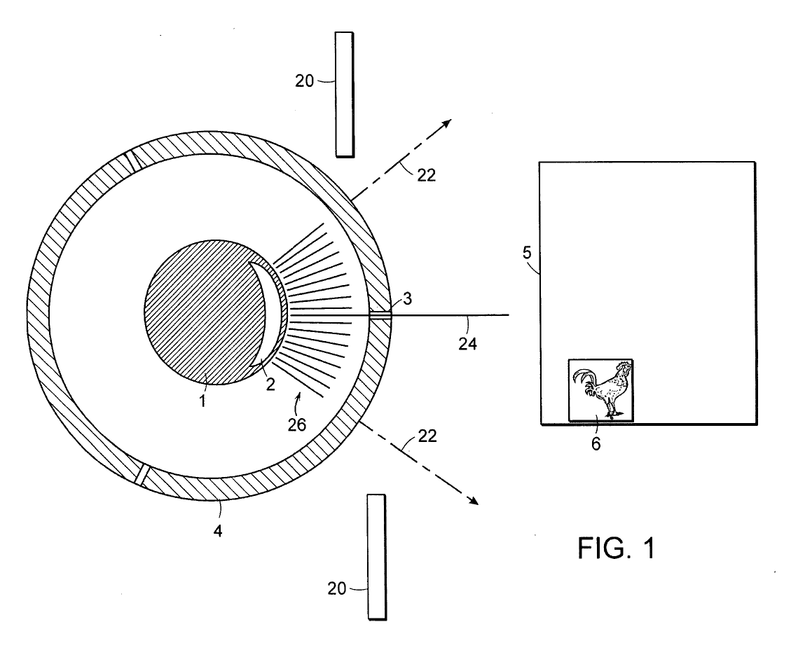

A description of embodiments of the present invention begins by reference to FIG. 1, where the main components of a prior art backscatter, or Compton scatter-based, imaging system are depicted schematically. X-ray scatter detectors 20 are preferably large, limited only by the size of the conveyance in which the x-ray source is placed. A source of penetrating radiation, that may be an x-ray tube 1, for example, has a primary collimating aperture 2. X-ray tube 1 and primary collimating aperture 2 are disposed in the interior portion, not necessarily in the center, of a moving collimator 4 or other spatial modulator. The penetrating radiation is described herein as x-ray radiation, however the use of other penetrating radiation, such as gamma radiation, is within the scope of the present invention. Spatial modulator 4 may be a wheel, with a series of collimating moving apertures 3. As the wheel rotates, or alternative moving collimator causes the propagation direction of the penetrating radiation to vary, different portions 24 of an x-ray beam 26 exiting the primary collimator are allowed to pass through the moving apertures 3, effectively scanning the x-ray beam in one dimension, and subtending a total field of view limited by primary collimating aperture 2. Limits of the total field of view are designated by dashed lines 22.

Scanning of exiting x-ray beam 24 in two orthogonal directions gives rise to a two dimensional image 6 (represented by an image of a rooster) of the object 5 under inspection.

For many applications, however, particularly for the detection of explosives at greater distances, a desirable tradeoff entails substantially reducing the angular field of view and as result simultaneously increasing X-ray flux dramatically within this smaller field of view. In this way, because of the increased flux, detectability of potential threats is improved in the region selected, even if range to the object is increased substantially. This option is particularly useful in a situation where an operator would like to investigate further a potential threat that is perhaps poorly defined due to an x-ray flux level that renders it barely visible.

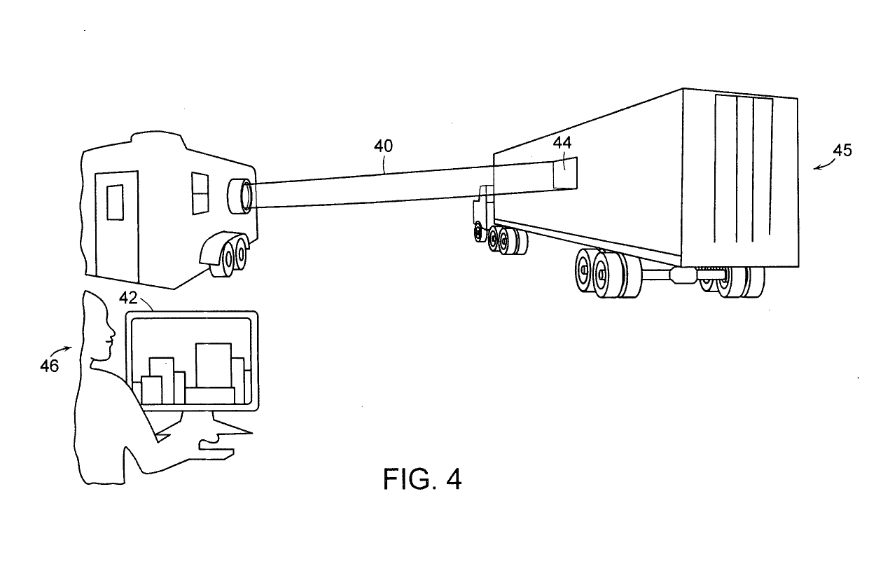

An aspect of x-ray backscatter imaging systems, not often appreciated, is that the quality of the image as a function of range for such systems does not degrade as 1/r⁴ for threat objects that are large compared to the x-ray beam dimensions, as one might expect, since both the area subtended by the irradiating beam and the area subtended by the detector increase as r². Degradation of image quality as 1/r⁴ would hold true, for example, of a distant object illuminated by a flashlight and imaged by a camera. The reason this does not hold true for x-ray backscatter systems can be described as follows: A scanning pencil beam 26 is typically used in a backscatter system in order to instantaneously define the region of the object under inspection that is being irradiated. From this region, a relatively large detector 20 or detectors collect a swath of radiation scattered from this object region in a generally backward direction. This signal is then made to correspond to a point on the operator display 42 (shown in FIG. 4). As the beam is scanned, for example in a vertical direction, a line of pixels are displayed, each pixel corresponding to an instantaneously irradiated region on the target object. While this vertical scan is being performed, a second motion, typically in a horizontal direction, provides the information for the two-dimensional image presented to the operator.

Now, consider the beam expansion as it travels outward from the X-ray source, and imagine an object that is irradiated at a variety of distances. In this case, the cross-sectional area of the outgoing X-ray beam itself expands as 1/r², as does the region of the object that is being irradiated. However, the larger irradiated region of the object is still imaged onto a single point in the operator display. Thus the X-ray flux corresponding to each point of the display, not counting the relatively small attenuation of the beam from the intervening air in the beam path, has not changed, as long as the object is larger than the beam. Resolution, of course, suffers, but not flux per pixel. Experiments show that the resolution degradation is tolerable for most applications as long as the beam size is smaller than roughly 1 or 2 inches in diameter. Of course, the requirement to keep this beam size small as distance to the target object increases implies that both tube focal spot size and the aperture size of the beam forming apparatus 4 (often referred to as a chopper wheel) should preferably be kept small enough to fit this beam geometry criterion. This would require, for a spot size on the target object of 1 or 2 inches in diameter, an initial beam size of approximately 1 mm at the chopper wheel aperture is desirable. For reference purposes, this aperture is approximately 30% of the area of the aperture currently used in shorter range imaging. This corresponds approximately to a 1/r dependence with distance, rather than 1/r² for the outgoing beam, as long as the object is much larger than the beam. For the return signal, of course, the solid angle subtended by the detectors varies as 1/r², so that the decrement in signal can be mitigated if the detectors are forward deployed nearer to the object itself. Thus, the range of the system may be further increased in those applications supporting forward deployment of the detectors.

Analysis shows that by restricting the field-of-view to a 1 meter×1 meter area, and assuming a 4 second scan time, significantly greater system range is possible. This alone increases pixel dwell time, relative to typical current systems, by a factor of close to 800 times. In addition, with recent improvements in available X-ray tube power, substantial additional X-ray flux can be placed on target at a resolution consistent with detecting explosives. Of course, it is possible to achieve still higher detection and/or range if scan time is allowed to increase even more.

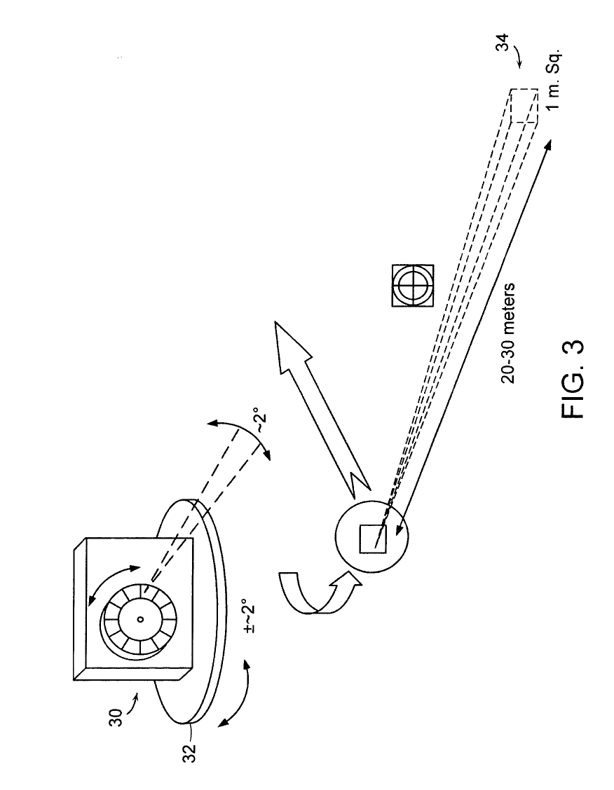

A backscatter inspection system in accordance with an embodiment of the present invention is described with reference to FIG. 3. A source of penetrating radiation includes a device for producing penetrating radiation that may be x-ray or gamma ray radiation, and may be an x-ray tube (designated by numeral 1 in FIG. 1), for example. The source includes a spatial modulator 4, in this case, shown as slits in a chopper wheel 30 that scan the beam of penetrating radiation vertically, and a turntable 32 that provides horizontal motion of the beam. It is important to note that a 1 meter×1 meter target area 34, positioned meters from the X-ray source, subtends an angle of only 2° in each direction. This in turn implies that the scan angles needed to create an image are relatively small, and easily provided by, for example, an aperture that scans vertically over a 2° angle, combined with, for example, a horizontally rotating scanner capable of traversing an equivalently small angle. The source of penetrating radiation may include one or more rotating chopper wheels, where the chopper wheels may be interchangeable by automated or other means. If the fan beam collimator is changed, the field of view may be narrowed or widened, whereas varying the aperture dimensions allows modification of the flux and resolution.

In one embodiment of the present invention, now described with reference to FIG. 4, the x-ray backscatter system includes a searchlight beam 40, in the visible or other non-penetrating portion of the electromagnetic spectrum, substantially contiguous with the x-ray scan field, both the searchlight beam and the x-ray scan field illuminating an area (of the order of 1 meter×1 meter in area) 44 on a container 45 (or other inspection target) typically on the order of 30 meters away, for example. This serves to define more accurately the particular region of the container that is currently being inspected. Simultaneously, a display 42 presents an operator 46 with backscatter x-ray images of the contents of that particular part of the container. At distances such as these, the effect of air scatter into the detectors must also be considered. If not addressed, air scatter would have the effect of causing a fog-like effect on the target image. One relatively simple solution to this is to place vanes in front of the backscatter detector that are aimed only at the targeted region of the threat object. In this way, a large fraction of the air scatter will be removed from the image.

In other embodiments of the present invention, a camera, in the visible or infrared portion of the spectrum, for example, may include, in its display, a region contiguous with, and defining for the operator, the region at the inspected object that is scanned by the penetrating radiation.

In accordance with alternate embodiments of the present invention, an x-ray backscatter system such as described above is placed on a mobile vehicle, or towed in a trailer, or placed on a fixed pedestal to interrogate vehicles and other objects that may be entering a secure zone.

Although various exemplary embodiments of the invention have been disclosed, it should be apparent to those skilled in the art that various changes and modifications can be made which will achieve some of the advantages of the invention without departing from the true scope of the invention. For example, the range may be measured, using ranging methods known in the art, so that the spatial resolution at the inspected target of the beam of penetrating radiation may readily be determined and displayed to the operator. Ranging methods may be chosen, by way of example and without limitation, from the group including radar, ultrasound, optical, and laser sensors. All such various embodiments, changes and modifications are to be understood to be within the scope of the present invention as described herein and as claimed in any appended claims.

What is claimed is:

1. An inspection system for inspecting an object, the system comprising:
a. a source of penetrating radiation characterized by a range of wavelengths;
b. a spatial modulator for forming the penetrating radiation into a beam of penetrating radiation for irradiating the object with a profile scanned in two dimensions, the object disposed entirely outside the enclosing body;
c. a remote spatial registration mechanism for defining an area at the object substantially contiguous with the profile scanned by the penetrating radiation; and
d. a detector module capable of detecting a scatter signal of penetrating radiation from contents of the object.

2. An inspection system in accordance with claim 1, wherein the spatial modulator includes at least one of a chopper wheel, a rotating stage, and a translating stage.

3. An inspection system in accordance with claim 1, wherein the remote spatial registration mechanism includes a source of electromagnetic radiation at a wavelength distinct from that of the range of wavelengths of the penetrating radiation, for subtending an area at the object substantially contiguous with the profile scanned by the penetrating radiation.

4. An inspection system in accordance with claim 3, wherein the electromagnetic radiation at a wavelength distinct from that of the band of wavelengths of the penetrating radiation is a visible searchlight beam.

5. An inspection system in accordance with claim 1, wherein the remote spatial registration mechanism includes a camera used to define the target area.

6. An inspection system in accordance with claim 1, wherein the source of penetrating radiation is disposed upon a vehicle capable of autonomous road travel.

7. An inspection system in accordance with claim 1, wherein the source of penetrating radiation is disposed upon a conveyance towed by a vehicle.

8. An inspection system in accordance with claim 1, wherein the source of penetrating radiation is chosen from a group including an x-ray tube and a source of gamma rays.

9. An inspection system in accordance with claim 1, wherein the source of penetrating radiation includes one or more rotating chopper wheels with scanning apertures for generating a scanning pencil beam.

10. An inspection system in accordance with claim 1, wherein the source of penetrating radiation includes an aperture that is mechanically moved in a rectilinear fashion along with the x-ray source.

11. An inspection system in accordance with claim 1, wherein the source of penetrating radiation includes an aperture that is mechanically moved in a rotational fashion along with the x-ray source.

12. An inspection system in accordance with claim 1, wherein the source of penetrating radiation includes a plurality of rotating chopper wheels, where the chopper wheels may be interchangeable by automated or other means, in order to permit the field of view to narrowed or widened.

13. An inspection system in accordance with claim 1, wherein the source of penetrating radiation includes one or more interchangeable chopper wheels, the chopper wheels not all having identical aperture sizes.

14. An inspection system in accordance with claim 1, wherein detectors of radiation scattered by the target object are coupled to a conveyance.

15. An inspection system in accordance with claim 1, wherein the detector module of the radiation scattered by the target object is deployed remotely from the source of penetrating radiation.

16. An inspection system in accordance with claim 1, wherein the distance to the object under inspection is determined by one or more sensors chosen from the group of radar, ultrasound, optical, and laser sensors.

17. An inspection system in accordance with claim 1, wherein the distance to the object under inspection is noted on the image screen to help the viewer assess the actual size of the perceived threat.

18. An inspection system in accordance with claim 1, wherein moveable vanes are disposed in front of the detector module to limit radiation received to that scattered from the targeted region.

19. A method for inspecting an object, the method comprising:
a. providing penetrating radiation characterized by a range of wavelengths;
b. forming the penetrating radiation into a beam;
c. scanning the object with a profile in two dimensions;
d. defining an area at the object substantially contiguous with the profile scanned by the penetrating radiation; and
e. detecting a scatter signal of penetrating radiation from contents of the object.

20. A method for inspecting an object in accordance with claim 19, wherein the step of defining an area substantially contiguous with the profile scanned by the penetrating radiation includes illuminating the area with a beam of non-penetrating electromagnetic radiation.
